(19) United States
(12) Patent Application Publication
(10) Pub. No.: US 2026/0088679 A1
(43) Pub. Date: Mar. 26, 2026

(54) MOTOR

(71) Applicant: NIDEC INSTRUMENTS CORPORATION, Nagano (JP)

(72) Inventor: Kentaro IMAI, Nagano (JP)

(73) Assignee: NIDEC INSTRUMENTS CORPORATION, Nagano (JP)

(21) Appl. No.: 19/322,598

(22) Filed: Sep. 8, 2025

(30) Foreign Application Priority Data
Sep. 20, 2024 (JP) 2024-163834

(51) Int. Cl. H02K 5/22; H02K 3/28

(52) U.S. Cl. CPC H02K 5/225; H02K 3/28; H02K 2203/03; H02K 2211/03

(57) ABSTRACT

A motor includes a rotor, a stator, a motor case in which the rotor and the stator are accommodated, and a power supply circuit board that is disposed outside the motor case. The circuit board is formed in a flat plate shape that protrudes toward an outer side in a radial direction of the rotor. In the motor, because the circuit board is formed in a flat plate shape that protrudes toward the outer side in the radial direction of the rotor, it is possible to reduce the size of the motor in the axial direction of the rotor, even if the length of the circuit board formed in a flat plate shape becomes long.

### CROSS REFERENCE TO RELATED APPLICATION

The present application claims priority under 35 U.S.C. § 119 to Japanese Application No. 2024-163834 filed Sep. 20, 2024, the entire content of which is incorporated herein by reference.

### TECHNICAL FIELD

At least an embodiment of the disclosure relates to a motor.

### DESCRIPTION OF THE RELATED DOCUMENTS

Conventionally, the terminal unit structure of a motor, which is used in motors such as stepping motors, is known (see, for example, Japanese Patent No. 3155209). The terminal unit structure described in Japanese Patent No. 3155209 includes a board holder that is attached to a terminal opening portion of a motor case, and a power supply terminal board that is held by the board holder. The terminal board is formed with terminal holes into which terminal pins are inserted, and the terminal pins inserted into the terminal holes are fixed by soldering to the terminal board. The board holder and the terminal board are disposed outside the motor case. The terminal board is formed in a substantially square and flat plate shape. The terminal board, which is formed in a flat plate shape, is disposed so as to be parallel to the axial direction of a rotor. That is, the terminal board is disposed such that the thickness direction of the terminal board and the radial direction of the rotor coincide.

The inventor has developed a motor that, for example, like the motor described in Japanese U.S. Pat. No. 3,155,209, includes a power supply circuit board that is disposed outside the motor case. The circuit board is a rigid board, such as a glass epoxy board, and is formed in a flat plate shape. Terminal pins are electrically connected to the circuit board. A drive coil disposed inside the motor case is electrically connected to the terminal pins. The inventor is investigating the mounting of a relatively large electronic component or a plurality of electronic components on the circuit board of a motor that is currently under development.

For example, the inventor is investigating the mounting of a relatively large electronic component, such as a drive integrated circuit (IC), or a plurality of electronic components on the circuit board so that various motor controls can be performed by the motor alone. In order to mount a relatively large electronic component or a plurality of electronic components on the circuit board, for example, the mounting area of the circuit board can be increased by increasing the length of the circuit board that is formed in a flat plate shape. However, if the length of the circuit board that is formed in a flat plate shape becomes longer, there is a concern that the motor will increase in size in the axial direction of the rotor.

Therefore, at least an embodiment of the disclosure provides a motor that includes a power supply circuit board that is disposed outside a motor case, in which the motor can be reduced in size in the axial direction of the rotor, even if the length of the circuit board that is formed in a flat plate shape becomes longer.

### SUMMARY

A motor according to an aspect of at least an embodiment of the disclosure includes: a rotor; a stator; a motor case in which the rotor and the stator are accommodated; and a power supply circuit board that is disposed outside the motor case; wherein the circuit board is formed in a flat plate shape that protrudes toward an outer side in a radial direction of the rotor.

In the motor according to the present aspect, the circuit board is formed in a flat shape that protrudes toward the outer side in the radial direction of the rotor. Therefore, even if the length of the circuit board that is formed in a flat plate shape becomes longer, the motor can be reduced in size in the axial direction of the rotor.

As described above, according to an aspect of at least an embodiment of the disclosure, in a motor including a power supply circuit board that is disposed outside a motor case, the motor can be reduced in size in the axial direction of the rotor, even if the length of the circuit board formed in a flat plate shape becomes longer.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a perspective view of a motor according to at least an embodiment of the disclosure;

FIG. 2 is a cross-sectional view of the motor shown in FIG. 1;

FIG. 3 is a perspective view of the bobbin shown in FIG. 2;

FIG. 4 is a plan view of the motor shown in FIG. 1 in a state where a second cover member has been removed;

FIG. 5 is a perspective view of the first cover member shown in FIG. 1 viewed from a different direction;

FIG. 6 is a perspective view of the second cover member shown in FIG. 1 viewed from a different direction;

FIG. 7 is a plan view for describing the configuration of an attachment section at which the first cover member is attached to the motor case shown in FIG. 1; and

FIG. 8 is a perspective view for describing the configuration of an attachment section at which the second cover member is attached to the bobbin shown in FIG. 2.

### DETAILED DESCRIPTION

Hereinafter, at least an embodiment of the disclosure will be described with reference to the drawings.

### Overall Configuration of Motor

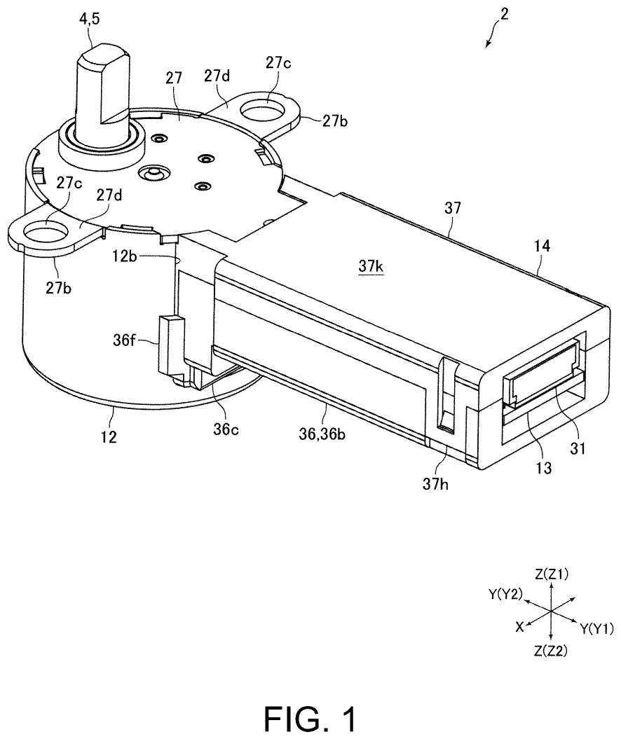

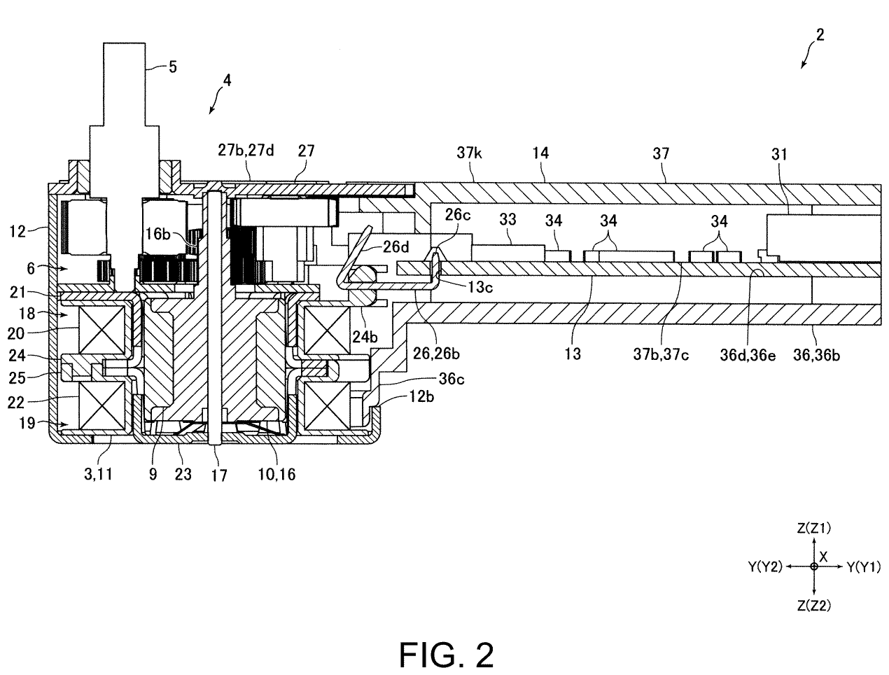

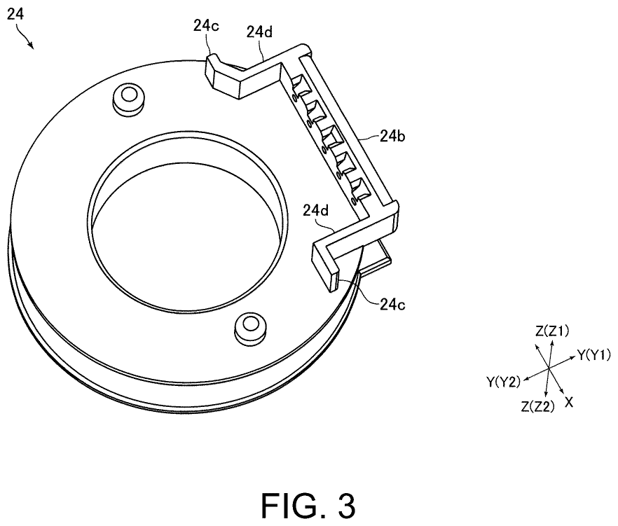

FIG. 1 is a perspective view of a motor 2 according to at least an embodiment of the disclosure. FIG. 2 is a cross-sectional view of the motor 2 shown in FIG. 1. FIG. 3 is a perspective view of a bobbin 24 shown in FIG. 2.

The motor 2 of the present embodiment is a geared motor. The motor 2 includes a motor body 3 and a reduction gear mechanism 4. The reduction gear mechanism 4 includes a rotating shaft 5, which serves as an output shaft of the motor 2, and a reduction gear train 6. The reduction gear train 6 includes a plurality of gears. The motor body 3 is a stepping motor. Specifically, the motor body 3 is a so-called PM type stepping motor. Furthermore, the motor body 3 is a two-phase stepping motor. The motor body 3 includes a rotor 10 having a drive magnet 9, and a stator 11 disposed on the outer peripheral side of the drive magnet 9.

In addition, the motor 2 includes a motor case 12 in which the rotor 10 and the stator 11 are accommodated, a power supply circuit board 13 that is disposed outside the motor case 12, and a cover member 14 that covers the circuit board 13. In the following description, the axial direction of the rotor 10 (the Z direction in FIG. 1 and the like) is referred to as the “up-down direction”. The Y direction in FIG. 1 and the like, which is orthogonal to the up-down direction, is referred to as the “left-right direction”. Further, the X direction in FIG. 1 and the like, which is orthogonal to the up-down direction and the left-right direction, is referred to as the “front-rear direction”. The left-right direction is a radial direction of the rotor 10 that is orthogonal to the axial direction of the rotor 10. The front-rear direction is also a radial direction of the rotor 10 that is orthogonal to the axial direction of the rotor 10. The up-down direction is also the axial direction of the rotating shaft 5.

Moreover, in the following description, the Z1 direction side in FIG. 1 and the like, which is one side in the up-down direction, is referred to as the “upper” side. The Z2 direction side in FIG. 1 and the like, which is on the opposite side to the upper side, is referred to as the “lower” side. The Y1 direction side in FIG. 1 and the like, which is one side in the left-right direction, is referred to as the “right” side. The Y2 direction side in FIG. 1 and the like, which is on the opposite side to the right side, is referred to as the “left” side. The upper side (Z1 direction side) in the present embodiment is a first direction side, which is one side in the axial direction of the rotor 10, and the lower side (Z2 direction side) is a second direction side, which is the opposite side to the first direction side (the other side in the axial direction of the rotor 10). Also, in the present embodiment, the upper side is the output side of the motor 2, and the lower side is the non-output side of the motor 2.

As described above, the motor body 3 includes the rotor 10 and the stator 11. The rotor 10 includes a rotating shaft 16 to which the drive magnet 9 is fixed. The rotating shaft 16 is formed in a cylindrical shape. A fixed shaft 17 is disposed on the inner peripheral side of the rotating shaft 16. The fixed shaft 17 is disposed such that the axial direction of the fixed shaft 17 and the up-down direction coincide. A lower end portion of the fixed shaft 17 is held by a bottom portion (lower surface portion) of the motor case 12. An upper end portion of the fixed shaft 17 is held by an end plate 27, which will be described later.

The rotating shaft 16 rotates with the up-down direction as the axis of rotation. An upper end side section of the rotating shaft 16 serves as an output shaft 16b that protrudes toward the upper side from the stator 11. The reduction gear train 6 is connected to the output shaft 16b. The drive magnet 9 is a permanent magnet, and is formed in a substantially cylindrical shape. The drive magnet 9 is fixed to the outer peripheral surface of a lower end side section of the rotating shaft 16. The outer peripheral surface of the drive magnet 9 has N poles and S poles alternatingly formed along the circumferential direction of the rotor 10.

The stator 11 includes an A-phase stator portion 18 and a B-phase stator portion 19 that overlap in the up-down direction. The stator portion 18 is disposed on the upper side of the stator portion 19. The stator portion 18 is disposed on the outer peripheral side of an upper end side section of the drive magnet 9, and the stator portion 19 is disposed on the outer peripheral side of a lower end side section of the drive magnet 9. The stator portion 18 includes a drive coil 20 and a stator core 21. The stator portion 19 includes a drive coil 22 and a stator core 23. The reduction gear train 6 is disposed on the upper side of the stator 11 and the drive magnet 9.

The drive coil 20 is wound around a bobbin 24, and the drive coil 22 is wound around a bobbin 25. That is, the stator 11 includes the bobbins 24 and 25. The stator cores 21 and 23 are formed with a plurality of pole teeth that face the outer peripheral surface of the drive magnet 9. The drive coil 20 and the bobbin 24 are disposed on the outer side of the plurality of pole teeth of the stator core 21 in the radial direction of the rotor 10. The drive coil 22 and the bobbin 25 are disposed on the outer side of the plurality of pole teeth of the stator core 23 in the radial direction of the rotor 10.

The stator core 21 is constituted by an outer stator core having a disc-shaped end plate portion that is disposed on the upper side of the drive coil 20, and an inner stator core having a disc-shaped end plate portion that is disposed on the lower side of the drive coil 20. The stator core 23 is constituted by an outer stator core having a disc-shaped end plate portion that is disposed on the lower side of the drive coil 22, and an inner stator core having a disc-shaped end plate portion that is disposed on the upper side of the drive coil 22.

Furthermore, the stator 11 includes a plurality of terminal pins 26 to which the drive coils 20 and 22 are electrically connected. The stator 11 of the present embodiment includes five terminal pins 26. The bobbin 24 is formed with a terminal block 24b that holds the five terminal pins 26. The terminal block 24b is formed on an upper-right end portion of the bobbin 24. The terminal block 24b is formed in a rectangular parallelepiped shape that protrudes toward the right side. In addition, the terminal block 24b is formed in a rectangular parallelepiped shape that is elongated in the front-rear direction. The five terminal pins 26 held by the terminal block 24b are aligned leaving a fixed spacing in the front-rear direction. The terminal pins 26 are electrically connected to the circuit board 13. The specific configuration of the terminal pins 26 will be described later.

As shown in FIG. 3, the bobbin 24 is formed with engaging portions 24c, to which a second cover member 37 described later, which constitutes a portion of the cover member 14, becomes engaged. The engaging portions 24c are formed in a flat plate shape with the thickness direction being in the left-right direction. The engaging portions 24c are formed at two locations. The engaging portions 24c are disposed further on the left side than the terminal block 24b. Furthermore, the two engaging portions 24c are disposed further on the outer side in the front-rear direction than the terminal block 24b. The terminal block 24b and the engaging portions 24c are connected by connecting portions 24d. The surface of the connecting portions 24d on the outer side in the front-rear direction are planes orthogonal to the front-rear direction.

The motor case 12 is formed in a bottomed cylindrical shape in which the upper end side is open. The motor case 12 of the present embodiment is integrally formed with the outer stator core of the stator core 23. The end plate portion of the outer stator core of the stator core 23 constitutes the bottom portion (lower surface portion) of the motor case 12. The motor case 12 constitutes the outer peripheral surface of the motor body 3, as well as the outer peripheral surface of the motor 2. The reduction gear train 6 and a lower end side section of the rotating shaft 5 are also accommodated in the motor case 12. Note that, the motor case 12 may be formed separately from the outer stator core of the stator core 23. In this case, for example, the end plate portion of the outer stator core of the stator core 23 is disposed on the upper side of the bottom portion of the motor case 12.

The motor case 12 is formed with an opening portion 12b that is recessed toward the lower side from the upper end surface of the motor case 12, and also penetrates the motor case 12 in the radial direction of the rotor 10. The opening portion 12b is formed in the right end portion of the motor case 12. The outer shape of the opening portion 12b when viewed from the right side is a rectangular shape. An end plate 27 is fixed to the upper end portion of the motor case 12. That is, the motor 2 includes the end plate 27 fixed to the upper end portion of the motor case 12.

The end plate 27 is formed in a flat plate shape with the thickness direction being in the up-down direction. The upper surface of the end plate 27 is a plane orthogonal to the up-down direction. An upper section of the rotating shaft 5 protrudes further toward the upper side than the upper surface of the end plate 27. The end plate 27 includes two attachment portions 27b that protrude toward both sides in the front-rear direction. The attachment portion 27b is formed with a circular through-hole 27c that penetrates the attachment portion 27b in the up-down direction. The upper surface of the attachment portion 27b serves as a planar attachment surface 27d for attaching the motor 2 to a predetermined host device. The attachment surface 27d is orthogonal to the up-down direction. The attachment surface 27d faces the upper side. The attachment surface 27d is disposed slightly further toward the upper side than the upper surface of the section of the end plate 27 other than the attachment portions 27b. A portion of a screw for attaching the motor 2 to the host device is placed in the through-hole 27c.

### Configuration of Circuit Board, Cover Member, and Terminal Pins

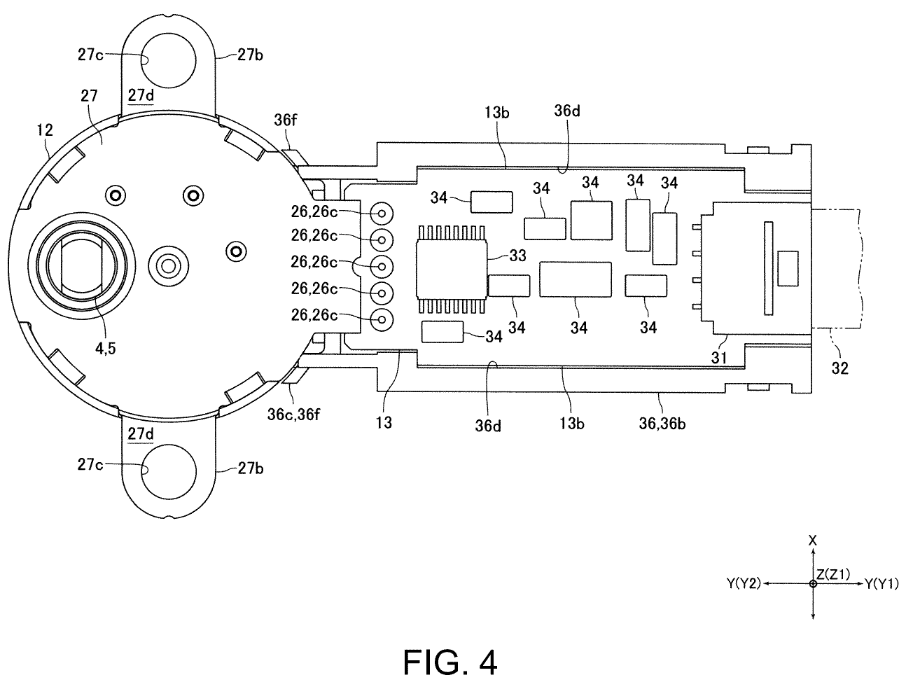

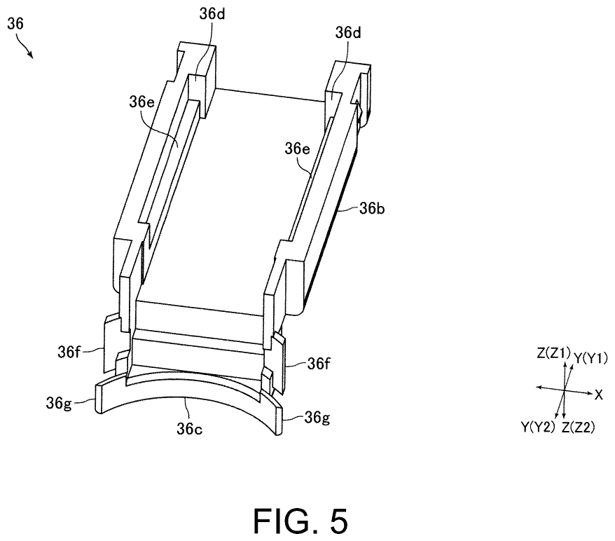

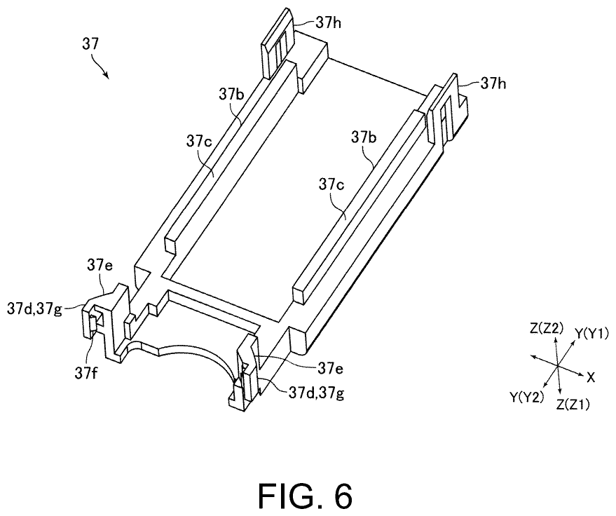

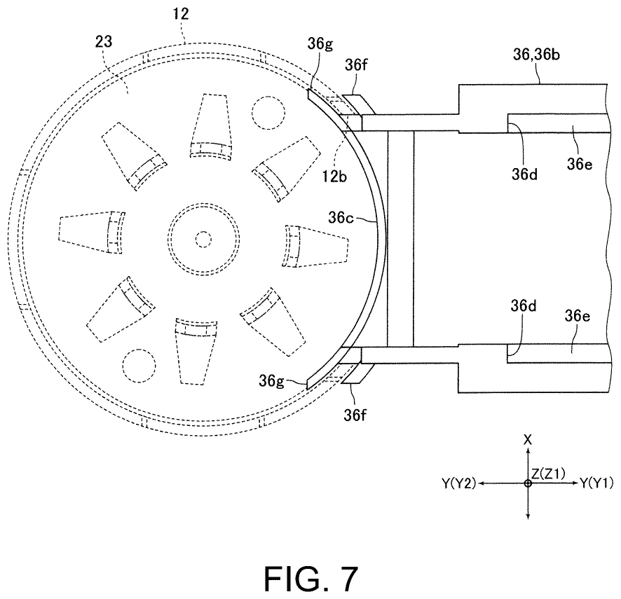

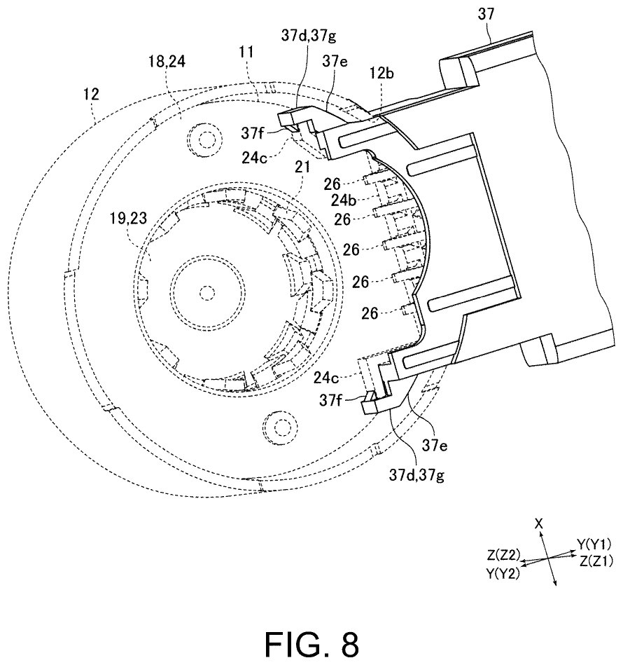

FIG. 4 is a plan view of the motor 2 shown in FIG. 1 in a state where the second cover member 37 has been removed. FIG. 5 is a perspective view of the first cover member 36 shown in FIG. 1 viewed from a different direction. FIG. 6 is a perspective view of the second cover member 37 shown in FIG. 1 viewed from a different direction. FIG. 7 is a plan view for describing the configuration of an attachment section at which the first cover member 36 is attached to the motor case 12 shown in FIG. 1. FIG. 8 is a perspective view for describing the configuration of an attachment section at which the second cover member 37 is attached to the bobbin 24 shown in FIG. 2.

The circuit board 13 serves the function of supplying power to the drive coils 20 and 22. The circuit board 13 is a rigid board, such as a glass epoxy board. The circuit board 13 is formed in a flat plate shape that protrudes toward the outer side in the radial direction of the rotor 10. The circuit board 13 of the present embodiment is formed in a flat plate shape that protrudes toward the right side. The thickness direction of the circuit board 13 coincides with the up-down direction. The circuit board 13 is formed in a rectangular flat plate shape in which the longer sides are in the left-right direction. The circuit board 13 extends toward the right side from the outer peripheral surface of the motor case 12. The circuit board 13 is disposed on the right side of the reduction gear train 6. The circuit board 13 is disposed at the same position as a lower end portion of the reduction gear train 6 in the up-down direction.

The circuit board 13 is formed with board-side engaging portions 13b that protrude toward the outer side in the front-rear direction (see FIG. 4). The board-side engaging portions 13b are formed at two locations on both sides of the circuit board 13 in the front-rear direction. The board-side engaging portion 13b is formed over a relatively wide area in the left-right direction. Both end surfaces of the board-side engaging portion 13b in the left-right direction are planes orthogonal to the left-right direction. The right end surface of the board-side engaging portion 13b is disposed further toward the left side than the right end surface of the circuit board 13. The left end surface of the board-side engaging portion 13b is disposed further toward the right side than the left end surface of the circuit board 13. The board-side engaging portion 13b is formed in an elongated rectangular shape in which the longer sides are in the left-right direction.

The circuit board 13 is formed with a plurality of pin placement holes 13c in which a portion of the terminal pins 26 are placed (see FIG. 2). In the present embodiment, five pin placement holes 13c are formed. The pin placement holes 13c are circular holes that penetrate the circuit board 13 in the up-down direction. The five pin placement holes 13c are formed in the left end portion of the circuit board 13. The five pin placement holes 13c are arranged leaving a fixed spacing in the front-rear direction.

As shown in FIG. 2, the terminal pin 26 includes a held portion 26b that is held by the terminal block 24b, a board connection portion 26c that is connected to the circuit board 13, and a coil fixing portion 26d to which the end portions of the drive coils 20 and 22 are fixed. The terminal pin 26 of the present embodiment is constituted by the held portion 26b, the board connection portion 26c, and the coil fixing portion 26d. The held portion 26b is formed in a straight line extending in the left-right direction. The right end of the held portion 26b is disposed further toward the right side than the terminal block 24b, and the left end of the held portion 26b is disposed further toward the right side of the terminal block 24b. The held portion 26b is disposed further toward the lower side than the circuit board 13.

The board connection portion 26c is formed in a straight line extending toward the upper side from the right end of the held portion 26b. The board connection portion 26c is inserted into the pin placement hole 13c of the circuit board 13 from the lower side. That is, a portion of the terminal pin 26 is inserted into the pin placement hole 13c from the lower side. The upper end of the board connection portion 26c is disposed further toward the upper side than the upper surface of the circuit board 13. The board connection portion 26c is fixed by soldering to the circuit board 13 on the upper surface side of the circuit board 13. The coil fixing portion 26d is formed in a straight line extending toward the diagonally upper right side from the left end of the held portion 26b. The end portions of the drive coils 20 and 22 are wound around and then fixed by soldering to the coil fixing portion 26d.

A connector 31 is mounted on the circuit board 13. The connector 31 is mounted on the upper surface of the right end portion of the circuit board 13. An insertion port of the connector 31 faces the right side. A mating connector 32 is inserted into the connector 31 from the right side. Furthermore, the mating connector 32 that has been inserted into the connector 31 is pulled out toward the right side. That is, the mating connector 32 is inserted into and removed from the connector 31 in the radial direction of the rotor 10.

In addition, a plurality of electronic components 33 and 34 are also mounted on the circuit board 13. For example, a single drive IC is mounted on the circuit board 13 as the electronic component 33. Also, a plurality of electronic components 34 other than the drive IC are mounted on the circuit board 13. The electronic components 33 and 34 are mounted on the upper surface of the circuit board 13. Note that some or all of the electronic components 33 and 34 may be mounted on the lower surface of the circuit board 13.

The cover member 14 protrudes toward the right side from the motor case 12. That is, the cover member 14 protrudes from the motor case 12 toward the outer side in the radial direction of the rotor 10. The cover member 14 is formed in a rectangular cylindrical shape that is elongated in the left-right direction, and both ends of the cover member 14 in the left-right direction are open. The cover member 14 covers the circuit board 13 from both sides in the up-down direction and both sides in the front-rear direction. The left end portion of the cover member 14 is engaged with the opening portion 12b of the motor case 12. That is, the end portion on the inner side of the cover member 14 in the radial direction of the rotor 10 is engaged with the opening portion 12b.

The cover member 14 includes the first cover member 36 and the second cover member 37, which are divided in the up-down direction. The cover member 14 of the present embodiment is constituted by the first cover member 36 and the second cover member 37. The second cover member 37 is disposed on the upper side of the first cover member 36. The second cover member 37 is attached to the first cover member 36 from the upper side. The length of the first cover member 36 in the left-right direction and the length of the second cover member 37 in the left-right direction are substantially equal. In the present embodiment, the second cover member 37 is fixed to the first cover member 36 by a snap-fit.

The first cover member 36 is constituted by a cover body 36b in which the circuit board 13 is housed, and a case engaging portion 36c that engages with the motor case 12. The cover body 36b is formed in a square groove shape with the upper surface and both ends in the left-right direction being open. The side surface portions of the cover body 36b in the front-rear direction are formed with a cover-side engaging portion 36d, which is recessed toward the outer side in the front-rear direction from the inner side surface in the front-rear direction of the side surface portion, and is also recessed toward the lower side from the upper surface of the side surface portion. Both surfaces of the cover-side engaging portion 36d in the left-right direction are planes orthogonal to the left-right direction. The lower surface of the cover-side engaging portion 36d is a plane orthogonal to the up-down direction.

The board-side engaging portion 13b of the circuit board 13 is disposed in the cover-side engaging portion 36d. The lower surface of the board-side engaging portion 13b is in contact with the lower surface of the cover-side engaging portion 36d. The right end surface of the board-side engaging portion 13b is in light contact with the right surface of the cover-side engaging portion 36d, or faces the right surface of the cover-side engaging portion 36d with a slight gap. The left end surface of the board-side engaging portion 13b is in light contact with the left surface of the cover-side engaging portion 36d, or faces the left surface of the cover-side engaging portion 36d with a slight gap.

The cover-side engaging portion 36d serves the function of restricting the movement of the circuit board 13 relative to the cover member 14 in the left-right direction. That is, the cover member 14 is formed with the cover-side engaging portion 36d to restrict the movement of the circuit board 13 in the left-right direction, which is the insertion and removal direction of the mating connector 32. The board-side engaging portion 13b is engaged with the cover-side engaging portion 36d. The lower surface of the cover-side engaging portion 36d serves as a first contact surface 36e that makes contact with the lower surface of the circuit board 13. That is, the first cover member 36 is formed with the first contact surface 36e.

The case engaging portion 36c protrudes toward the lower side from the left end portion of the cover body 36b. The case engaging portion 36c is formed with a curved plate-shaped outer placement portion 36f that is disposed on the outer side of the outer peripheral surface of the motor case 12, and a curved plate-shaped inner placement portion 36g disposed on the inner side of the inner peripheral surface of the motor case 12. The outer placement portion 36f and the inner placement portion 36g are formed on both sides of the case engaging portion 36c in the front-rear direction. The inner placement portion 36g is disposed on the left side and lower side of the outer placement portion 36f.

The outer placement portion 36f and the inner placement portion 36g are disposed so as to sandwich the motor case 12 at the edge of the opening portion 12b. The side surface (side surface in the front-rear direction) of the case engaging portion 36c between the outer placement portion 36f and the inner placement portion 36g is in light contact with the side surface (side surface in the front-rear direction) of the opening portion 12b, or faces the side surface of the opening portion 12b with a slight gap. The lower surface of the case engaging portion 36c disposed on the right side of the inner placement portion 36g is in contact with the lower surface of the opening portion 12b.

At both end portions of the second cover member 37 in the front-rear direction, convex portions 37b that protrude toward the lower side are formed. The convex portion 37b is formed in a rectangular parallelepiped shape that is elongated in the left-right direction. The convex portion 37b is disposed on the upper side of the cover-side engaging portion 36d. The lower surface of the convex portion 37b is a plane orthogonal to the up-down direction. The lower surface of the convex portion 37b serves as a second contact surface 37c that makes contact with the upper surface of the circuit board 13. That is, the second cover member 37 is formed with the second contact surface 37c that makes contact with the upper surface of the circuit board 13.

The second cover member 37 includes a terminal block engaging portions 37d that engages with the terminal block 24b. The terminal block engaging portions 37d protrude toward the lower side from the left end portion of the second cover member 37. The terminal block engaging portions 37d are formed at two locations in the front-rear direction of the second cover member 37. The terminal block engaging portion 37d is formed with a bobbin contact portion 37e that makes contact with the engaging portion 24c of the bobbin 24 from the right side, and a bobbin contact portion 37f that makes contact with the engaging portion 24c from the left side.

The surface of the bobbin contact portion 37e on the inner side in the front-rear direction is a plane orthogonal to the front-rear direction, and in the front-rear direction, is disposed on the outer side of the outer side surface of the connecting portion 24d in the front-rear direction. A joining portion 37g that connects the bobbin contact portion 37e and the bobbin contact portion 37f is disposed on the outer side of the engaging portion 24c in the front-rear direction. The section of the second cover member 37 on the right side of the bobbin contact portion 37e is disposed inside the opening portion 12b of the motor case 12.

At the right end portion of the second cover member 37, elastically deformable engaging pieces 37h is formed, which engage with the first cover member 36 by a snap-fit. The engaging pieces 37h are formed at two locations in the front-rear direction of the second cover member 37. The engaging piece 37h is elastically deformable in the front-rear direction. An upper surface 37k of the second cover member 37 is a plane orthogonal to the up-down direction. The upper surface 37k of the second cover member 37 is disposed on the same plane as the attachment surface 27d of the end plate 27. That is, the upper surface 37k, which becomes the upper surface of the cover member 14, is a plane disposed on the same plane as the attachment surface 27d.

During assembly of the motor 2, after the stator portion 19 is accommodated in the motor case 12 from the upper side, and the first cover member 36 is attached to the motor case 12 from the upper side, the stator portion 18, to which the terminal pins 26 have been attached, is accommodated in the motor case 12 from the upper side. Then, the circuit board 13 is placed inside the first cover member 36 from the upper side. At this time, the board connection portions 26c of the terminal pins 26 are inserted into the pin placement holes 13c of the circuit board 13. Then, the circuit board 13 and the board connection portions 26c are fixed by soldering from the upper side. Then, the second cover member 37 is attached to the first cover member 36 from the upper side.

### Main Effects of Present Embodiment

As described above, in the present embodiment, the circuit board 13 is formed in a flat plate shape that protrudes toward the outer side in the radial direction of the rotor 10. Therefore, in the present embodiment, even if the length of the circuit board 13 that is formed in a flat plate shape becomes longer, it is possible to reduce the size of the motor 2 in the axial direction of the rotor 10.

In the present embodiment, the motor 2 includes the cover member 14 that covers the circuit board 13. Therefore, in the present embodiment, it is possible to protect the electronic components 33 and 34 mounted on the circuit board 13 with the cover member 14. As a result, in the present embodiment, it is possible to prevent damage to the electronic components 33 and 34 mounted on the circuit board 13.

In the present embodiment, the cover member 14 is formed with the cover-side engaging portion 36d that restricts the movement of the circuit board 13 in the left-right direction, which is the insertion/removal direction of the mating connector 32 with respect to the connector 31, and the circuit board 13 is formed with the board-side engaging portion 13b that engages with the cover-side engaging portion 36d. Therefore, in the present embodiment, the force acting on the circuit board 13 when the mating connector 32 is inserted into or removed from the connector 31 can be received by the cover member 14. As a result, in the present embodiment, it is possible to prevent the connection section between the circuit board 13 and the terminal pins 26 from being damaged due to the attachment or detachment of the mating connector 32. Furthermore, in the present embodiment, it is possible to position the circuit board 13 with respect to the cover member 14 in the left-right direction with the board-side engaging portion 13b and the cover-side engaging portion 36d.

In the present embodiment, the first cover member 36 is formed with the first contact surface 36e that makes contact with the lower surface of the circuit board 13, and the second cover member 37 is formed with the second contact surface 37c that makes contact with the upper surface of the circuit board 13. Therefore, in the present embodiment, it is possible to position the circuit board 13 in the axial direction of the rotor 10 using the first cover member 36 and the second cover member 37.

In the present embodiment, the motor case 12 is formed with the opening portion 12b that is recessed toward the lower side from the upper end surface of the motor case 12, and the left end portion of the cover member 14 is engaged with the opening portion 12b. Furthermore, in the present embodiment, the second cover member 37 is disposed on the upper side of the first cover member 36, and is attached to the first cover member 36 from the upper side. In addition, in the present embodiment, the circuit board 13 is formed with the pin placement holes 13c that penetrate the circuit board 13 in the up-down direction, and a portion of the terminal pins 26 is inserted into the pin placement holes 13c from the lower side.

Therefore, in the present embodiment, as described above, during assembly of the motor 2, it is possible to sequentially attach the stator portion 19, the first cover member 36, the stator portion 18, the circuit board 13, and the second cover member 37 to the motor case 12 from the upper side in this order. As a result, in the present embodiment, it is possible to easily assemble the motor 2.

In the present embodiment, the attachment surface 27d for attaching the motor 2 to a host device and the upper surface 37k of the cover member 14 are disposed on the same plane orthogonal to the up-down direction. Therefore, in the present embodiment, it is possible to stabilize the state of the motor 2 when the motor 2 is attached to the host device.

### Other Embodiments

Although the embodiment described above is an example of an embodiment of the disclosure, the disclosure is not limited thereto, and various modifications can be made without departing from the gist of the disclosure.

In the embodiment described above, the circuit board 13 may be disposed on the lower side of the reduction gear train 6. In this case, for example, the board connection portion 26c of the terminal pin 26 is formed in a straight line extending toward the lower side from the right end of the held portion 26b and is inserted into the pin placement hole 13c of the circuit board 13 from the upper side. Furthermore, in this case, the upper surface 37k of the second cover member 37 may be disposed further toward the lower side than the attachment surface 27d. In addition, in the embodiment described above, the second cover member 37 does not include the terminal block engaging portion 37d. That is, the second cover member 37 does not need to be engaged with the bobbin 24.

In the embodiment described above, the circuit board 13 may be formed with a concave portion serving as a board-side engaging portion that is recessed toward the inner side in the front-rear direction, and the first cover member 36 may be formed with a convex portion serving as a cover-side engaging portion that protrudes toward the inner side in the front-rear direction from the inner side surface of the side surface portion of the cover body 36b in the front-rear direction. In this case, the convex portion of the first cover member 36 is engaged with the concave portion of the circuit board 13, and the movement of the circuit board 13 relative to the cover member 14 in the left-right direction is restricted by the concave portion and the convex portion (that is, by the board-side engaging portion and the cover-side engaging portion).

In the embodiment described above, the second cover member 37 may be attached to the first cover member 36 from the right side. In this case, the second cover member 37 does not include the terminal block engaging portion 37d. Furthermore, in this case, for example, the first cover member 36 may be formed with a restricting surface with which the left end surface of the board-side engaging portion 13b is in light contact, or faces with a slight gap, and the second cover member 37 may be formed with a restricting surface with which the right end surface of the board-side engaging portion 13b is in light contact, or faces with a slight gap. In this case, the restricting surface of the first cover member 36 and the restricting surface of the second cover member 37 constitute a cover-side engaging portion that restricts the movement of the circuit board 13 in the left-right direction.

Moreover, in this case, a first contact surface that makes contact with the lower surface of the circuit board 13 and a second contact surface that makes contact with the upper surface of the circuit board 13 may be formed on the first cover member 36, or the first contact surface and the second contact surface may be formed on the second cover member 37. Also, in this case, the length of the first cover member 36 in the left-right direction may be shorter than the length of the second cover member 37 in the left-right direction.

In the embodiment described above, the circuit board 13 does not have to be formed with the board-side engaging portion 13b. In this case, the cover member 14 is not formed with the cover-side engaging portion 36d. In addition, in the embodiment described above, the cover member 14 is constituted by two members, namely the first cover member 36 and the second cover member 37, but the cover member 14 may be constituted by a single member. Also, in the embodiment described above, the motor 2 does not have to include the cover member 14.

In the embodiment described above, the thickness direction of the circuit board 13 may be inclined with respect to the up-down direction. Specifically, the thickness direction of the circuit board 13 may be slightly inclined with respect to the up-down direction. Even in this case, the circuit board 13 protrudes toward the outer side in the radial direction of the rotor 10. Furthermore, in the embodiment described above, the motor body 3 may be a motor other than a stepping motor. Also, in the embodiment described above, the motor 2 does not have to be a geared motor. That is, the motor 2 does not have to include the reduction gear mechanism 4.

### Configuration of Present Technique

Note that the present technique can adopt the following configurations.

(1) A motor comprising:
a rotor;
a stator;
a motor case in which the rotor and the stator are accommodated; and
a circuit board for power supply that is disposed outside the motor case; wherein the circuit board is formed in a flat plate shape that protrudes toward an outer side in a radial direction of the rotor.

(2) The motor according to (1), wherein
a thickness direction of the circuit board coincides with an axial direction of the rotor.

(3) The motor according to (1) or (2), comprising a cover member that covers the circuit board.

(4) The motor according to (3), wherein
the circuit board has a connector mounted thereon,
a mating connector is inserted into and removed from the connector in the radial direction of the rotor,
the cover member is formed with a cover-side engaging portion to restrict movement of the circuit board in an insertion and removal direction of the mating connector, and
the circuit board is formed with a board-side engaging portion that engages with the cover-side engaging portion.

(5) The motor according to (3) or (4), wherein
the cover member comprises a first cover member and a second cover member that are divided in the axial direction of the rotor,
the first cover member is formed with a first contact surface that makes contact with one surface of the circuit board in the axial direction of the rotor, and
the second cover member is formed with a second contact surface that makes contact with an other surface of the circuit board in the axial direction of the rotor.

(6) The motor according to any one of (3) to (5), wherein
when a thickness direction of the circuit board coincides with the axial direction of the rotor, and one side in the axial direction of the rotor is a first direction side, and an other side in the axial direction of the rotor, being an opposite side to the first direction side, is a second direction side,
the stator comprises a drive coil and a plurality of terminal pins to which the drive coil is electrically connected,
the cover member comprises a first cover member and a second cover member that are divided in the axial direction of the rotor,
the motor case is formed with an opening portion that is recessed from an end surface on the first direction side of the motor case toward the second direction side, and penetrates the motor case in the radial direction of the rotor,
an end portion on an inner side of the cover member in the radial direction of the rotor engages with the opening portion,
the second cover member is disposed on the first direction side of the first cover member and is attached to the first cover member from the first direction side,
the circuit board is formed with a plurality of pin placement holes in which a portion of the terminal pins is placed,
the pin placement holes penetrate the circuit board in the axial direction of the rotor, and a portion of the terminal pins is inserted into the pin placement holes from the second direction side.

(7) The motor according to any one of (3) to (6), wherein
when one side in the axial direction of the rotor is a first direction side,
the motor comprises an end plate that is formed with a planar attachment surface to attach the motor to a host device, and is fixed to an end portion of the motor case on the first direction side,
the attachment surface is orthogonal to the axial direction of the rotor and faces the first direction side, and
a surface of the cover member on the first direction side is a plane disposed on a same plane as the attachment surface.

In the present technique, for example, the thickness direction of the circuit board coincides with the axial direction of the rotor.

In the present technique, for example, the motor includes a cover member that covers the circuit board. With such a configuration, it becomes possible to protect the electronic components mounted on the circuit board with the cover member. Therefore, it becomes possible to prevent damage to the electronic components mounted on the circuit board.

In the present technique, for example, the circuit board has a connector mounted thereon, a mating connector is inserted into and removed from the connector in the radial direction of the rotor, the cover member is formed with a cover-side engaging portion to restrict movement of the circuit board in an insertion and removal direction of the mating connector, and the circuit board is formed with a board-side engaging portion that engages with the cover-side engaging portion. With such a configuration, the force acting on the circuit board when the mating connector is inserted into or removed from the connector can be received by the cover member.

Therefore, it is possible to prevent the connection section (the section fixed by soldering) between the power supply circuit board and the terminal pins from being damaged due to the attachment and detachment of the mating connector. In addition, with such a configuration, it is possible to position the circuit board with respect to the cover member in the insertion and removal direction of the mating connector with the board-side engaging portion and the cover-side engaging portion.

In the present technique, for example, the cover member includes a first cover member and a second cover member that are divided in the axial direction of the rotor, the first cover member is formed with a first contact surface that makes contact with one surface of the circuit board in the axial direction of the rotor, and the second cover member is formed with a second contact surface that makes contact with an other surface of the circuit board in the axial direction of the rotor. In this case, it is possible to position the circuit board in the axial direction of the rotor using the first cover member and the second cover member.

In the present technique, when the thickness direction of the circuit board coincides with the axial direction of the rotor, and one side in the axial direction of the rotor is a first direction side, and an other side in the axial direction of the rotor, being an opposite side to the first direction side, is a second direction side, for example, the stator includes a drive coil and a plurality of terminal pins to which the drive coil is electrically connected, the cover member includes a first cover member and a second cover member that are divided in the axial direction of the rotor, the motor case is formed with an opening portion that is recessed from an end surface on the first direction side of the motor case toward the second direction side, and penetrates the motor case in the radial direction of the rotor, an end portion on an inner side of the cover member in the radial direction of the rotor engages with the opening portion, the second cover member is disposed on the first direction side of the first cover member and is attached to the first cover member from the first direction side, the circuit board is formed with a plurality of pin placement holes in which a portion of the terminal pins is placed, the pin placement holes penetrate the circuit board in the axial direction of the rotor, and a portion of the terminal pins is inserted into the pin placement holes from the second direction side.

With such a configuration, it becomes possible to firstly accommodate the stator in the motor case from the first direction side and attach the first cover member from the first direction side, place the circuit board inside the first cover member from the first direction side, and then fix the circuit board and the terminal pins by soldering from the first direction side. Furthermore, it becomes possible to then attach the second cover member to the first cover member from the first direction side. Therefore, it becomes possible to easily assemble the motor.

In the present technique, when one side in the axial direction of the rotor is a first direction side, for example, the motor includes an end plate that is formed with a planar attachment surface to attach the motor to a host device, and is fixed to an end portion of the motor case on the first direction side, the attachment surface is orthogonal to the axial direction of the rotor and faces the first direction side, and a surface of the cover member on the first direction side is a plane disposed on a same plane as the attachment surface. With such a configuration, it is possible to stabilize the state of the motor when the motor is attached to the host device.

What is claimed is:

1. A motor comprising:
a rotor,
a stator;
a motor case in which the rotor and the stator are accommodated; and
a circuit board for power supply that is disposed outside the motor case; wherein
the circuit board is formed in a flat plate shape that protrudes toward an outer side in a radial direction of the rotor.

2. The motor according to claim 1, wherein
a thickness direction of the circuit board coincides with an axial direction of the rotor.

3. The motor according to claim 1, comprising
a cover member that covers the circuit board.

4. The motor according to claim 3, wherein
the circuit board has a connector mounted thereon,
a mating connector is inserted into and removed from the connector in the radial direction of the rotor,
the cover member is formed with a cover-side engaging portion to restrict movement of the circuit board in an insertion and removal direction of the mating connector, and
the circuit board is formed with a board-side engaging portion that engages with the cover-side engaging portion.

5. The motor according to claim 3, wherein
the cover member comprises a first cover member and a second cover member that are divided in the axial direction of the rotor,
the first cover member is formed with a first contact surface that makes contact with one surface of the circuit board in the axial direction of the rotor, and
the second cover member is formed with a second contact surface that makes contact with an other surface of the circuit board in the axial direction of the rotor.

6. The motor according to claim 3, wherein
when a thickness direction of the circuit board coincides with the axial direction of the rotor, and one side in the axial direction of the rotor is a first direction side, and an other side in the axial direction of the rotor, being an opposite side to the first direction side, is a second direction side,
the stator comprises a drive coil and a plurality of terminal pins to which the drive coil is electrically connected,
the cover member comprises a first cover member and a second cover member that are divided in the axial direction of the rotor,
the motor case is formed with an opening portion that is recessed from an end surface on the first direction side of the motor case toward the second direction side, and penetrates the motor case in the radial direction of the rotor,
an end portion on an inner side of the cover member in the radial direction of the rotor engages with the opening portion,
the second cover member is disposed on the first direction side of the first cover member and is attached to the first cover member from the first direction side,
the circuit board is formed with a plurality of pin placement holes in which a portion of the terminal pins is placed,
the pin placement holes penetrate the circuit board in the axial direction of the rotor, and
a portion of the terminal pins is inserted into the pin placement holes from the second direction side.

7. The motor according to claim 3, wherein
when one side in the axial direction of the rotor is a first direction side,
the motor comprises an end plate that is formed with a planar attachment surface to attach the motor to a host device, and is fixed to an end portion of the motor case on the first direction side,
the attachment surface is orthogonal to the axial direction of the rotor and faces the first direction side, and
a surface of the cover member on the first direction side is a plane disposed on a same plane as the attachment surface.
